(19) United States
(12) Patent Application Publication
(10) Pub. No.: US 2019/0030769 A1
(43) Pub. Date: Jan. 31, 2019

(54) METHOD FOR PRODUCING A CLIMATE CONTROL BOX

(71) Applicant: Hanon Systems, Daejeon (KR)

(72) Inventors: Michael Sproule, Brighton, MI (US); Brian Cardwell, Ypsilanti, MI (US)

(21) Appl. No.: 16/147,944

(22) Filed: Oct. 1, 2018

Related U.S. Application Data
(62) Division of application No. 15/206,993, filed on Jul. 11, 2016.
(60) Provisional application No. 62/233,733, filed on Sep. 28, 2015.

(51) Int. Cl. B29C 44/42; B29C 44/34; B29C 44/58; B29C 44/60; B29C 44/02; B60H 1/00; B29K 105/16; B29K 105/04; B29K 105/00; B29K 101/12; B29K 77/00; B29K 75/00; B29K 55/02; B29K 33/04; B29K 27/06; B29K 23/00; B29L 31/30

(52) U.S. Cl. CPC B29C 44/42; B29L 2031/3002; B29C 44/58; B29C 44/60; B29C 44/02; B60H 1/00514; B29K 2105/16; B29K 2105/043; B29K 2105/0005; B29K 2101/12; B29K 2077/00; B29K 2075/00; B29K 2055/02; B29K 2033/04; B29K 2027/06; B29K 2023/12; B29K 2023/06; B29K 2105/251; B29K 2223/083; B29K 2995/0015; B29K 2995/0091; B29L 2031/30; B29C 44/3449

(57) ABSTRACT

A method of forming a component of a vehicle heating, ventilation, and air-conditioning system from polymeric material includes providing a molding system including at least one mold cavity defining the component. A base resin is introduced to the mold system via an inlet. A chemical foaming agent is blended with the base resin to form a composition. The composition is then further heated and blended under pressure, wherein the chemical foaming agent decomposes within the composition. The composition is introduced to the mold cavity, wherein a reduced minimized pressure of the mold cavity facilitates initiation of a nucleation of the composition, wherein the composition expands to fill the mold cavity.

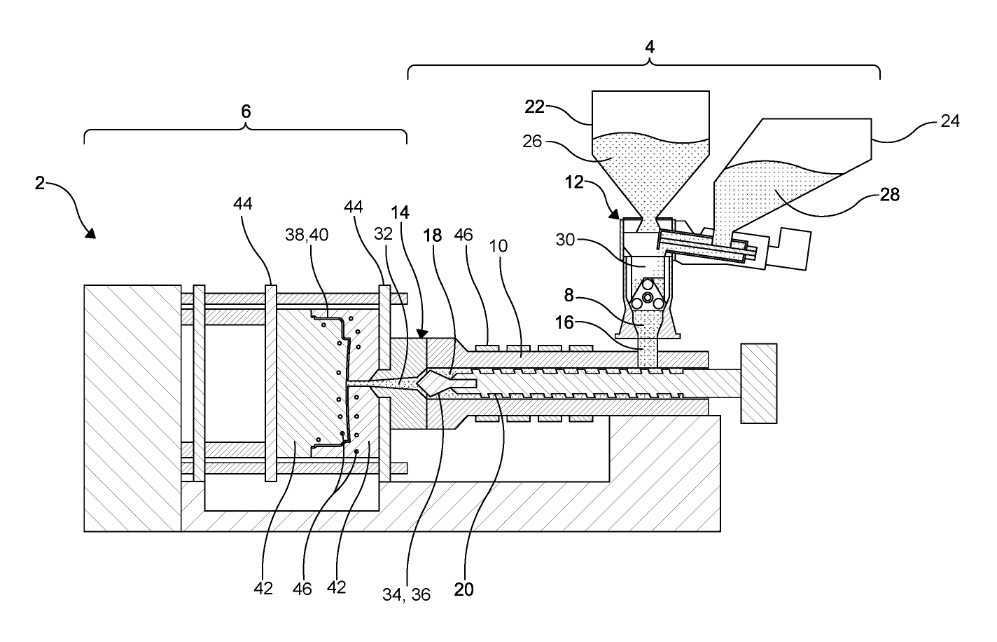

### CROSS-REFERENCES TO RELATED APPLICATIONS

This patent application is a divisional patent application of U.S. Utility patent application Ser. No. 15/206,993 filed on Jul. 11, 2016 which claims priority to U.S. Provisional Patent Application Ser. No. 62/233,733 filed on Sep. 28, 2015, the entire disclosures of which are hereby incorporated herein by reference.

### FIELD OF THE INVENTION

The invention relates to a method for producing a heating, ventilation, and air conditioning (HVAC) box for a vehicle, and more particularly, to producing a HVAC box for a vehicle using chemical foaming.

### BACKGROUND

There is a continuing effort in the automotive industry to reduce vehicle weight in order to improve vehicle efficiency. Particularly, a trend exists to minimize weight of polymeric components of heating, ventilation, and air-conditioning (HVAC) systems through changes that reduce part thickness and densities.

One current solution for minimizing the weight of polymeric HVAC components is known as physical foaming. Physical foaming involves entraining a compressed gas, such as Nitrogen, into a molten flow of polymeric material to form a homogenous mixture within the barrel of a molding system. The homogenous mixture is then introduced to a molding chamber and pressure is reduced, thereby allowing the homogenous mixture to nucleate, wherein the compressed gas within the mixture expands to form a suspension of bubbles within the polymeric material.

However, physical foaming processes involve high capital investment, as specialty molding equipment is required to inject the gas into the polymeric material, and to maintain the molten polymeric material in a highly compressed state prior to introduction into the molding chamber. Once the polymeric material is cooled in the mold, inherent stresses may form within the molded component, leading to deformation and failure over the life cycle of the component.

Another method for forming foamed polymeric HVAC components involves the blending of hollow glass bubbles into a base resin. The hollow glass bubbles serve to displace the base resin, thereby forming hollow cavities within the material to reduce overall density of the material.

Unlike physical foaming, hollow glass bubble foaming does not require auxiliary equipment to inject a compressed gas. Thus, conventional molding systems may be utilized. However, the addition of hollow glass spheres to the polymeric material increases overall material costs. Additionally, hollow glass sphere-containing resins are not offered by many suppliers, making sourcing of suitable materials more difficult and costly.

Yet another known method for producing lighter weight HVAC components involves the blending of alternative filler materials and/or reinforcing agents, or to use less filler materials and/or reinforcing agents in the injection molding resins. For example, one common type of base resin used in injection molding is a polypropylene containing approximately 20% talc as a filler material. However, talc has a higher density than polypropylene, thereby increasing the overall weight of the material. Thus, it may be advantageous to reduce the concentration of talc within the base resin in an effort to minimize overall weight. Alternatively, at least a portion of the talc may be substituted with filler materials having a lower density.

However, the reduction of the concentration of talc may be undesirable for multiple reasons. Initially, the physical properties of the base resin may be negatively affected by removing or substituting the talc. Additionally, base resin blends having less than 20% talc are not commonly manufactured by suppliers, and costs to obtain these alternative base resins may be prohibitively high.

In addition to the aforementioned shortcomings in the art, part fit-and-finish and dimensional control is difficult to achieve due to increasingly complex part geometries combined with the desire for reduced wall thicknesses. For example, thinner wall sections make it progressively harder to inject molten material into a mold and achieve even pack pressure. There is also a desire in the art to minimize residual stresses created during cooling and re-crystallization of the thermoplastic, and to prevent the anisotropy of fillers and reinforcing agents.

Accordingly, there exists a need in the art for an improved means of forming polymeric components of a HVAC system, wherein the process utilizes conventional injection molding equipment, minimizes raw material costs, and minimizes inherent stresses.

### SUMMARY OF THE INVENTION

In concordance with the instant disclosure, an improved process for forming polymeric components of a HVAC system, wherein the process utilizes conventional injection molding equipment, minimizes raw material costs, and minimizes inherent stress is surprisingly discovered.

In one embodiment, the foaming means involves the introduction of endothermic chemical foaming agent to an injection molding resin prior to molding. The introduction of chemical foaming agent results in molded articles having a reduced weight, reduced cycle times, reduced pressure and energy consumption, and improved dimensional control, thermal insulation, and noise and vibrational damping compared to those of the prior art.

A method of forming a component of a vehicle HVAC system from a polymeric material includes providing a molding system including at least one mold cavity, including a die configured to form a component of a vehicle HVAC system. A composition including a base resin and a chemical foaming agent is then provided to the mold cavity, wherein a pressure drop within the mold cavity is configured to initiate a nucleation of the foaming agent within the base resin. Nucleation of the chemical foaming agent forms a plurality of gas bubbles, creating a cellular structure within the composition and causing the composition to expand to fill the mold cavity.

A system for forming a component of a vehicle HVAC system from a polymeric material includes a mold and an injector. The mold includes a mold cavity having a definition corresponding to a profile of an HVAC component. The injector is in fluid communication with the mold cavity. The system further comprises a composition including a base resin and a chemical foaming agent. The injector is configured to heat the composition to a first temperature configured to initiate a decomposition of the chemical foaming agent, and a pressure of the mold cavity is configured to initiate a nucleation of the chemical foaming agent in the composition.

A component for a vehicle HVAC system includes at least one thin-walled section formed of a polymeric material. The polymeric material is formed of a composition including a base resin and a chemical foaming agent, wherein the thin-walled section of the component has a cellular core and a solidly formed surface layer.

### BRIEF DESCRIPTION OF THE DRAWING

The FIGURE is a schematic cross-sectional elevational view of an injection molding system for forming HVAC components according to an embodiment of the instant disclosure.

### DETAILED DESCRIPTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

As shown in the FIGURE, a molding system 2 for carrying out an embodiment of the disclosure is shown. The molding system 2 includes an injector 4 and a mold 6 in fluid communication with each other, wherein the injector 4 is configured to provide a flow of a composition 8 to the mold 6.

The injector 4 includes a barrel 10, a feed system 12, and a head 14. The barrel 10 of the injector 4 includes at least one inlet 16 in fluid communication with the feed system 12, and an outlet 18 in communication with the head 14. The barrel 10 further includes a screw 20 rotatably disposed therein and configured to convey the composition 8 from the feed system 12 to the head 14.

The feed system 12 of the injector 4 is configured to provide the composition 8 to an interior of the barrel 10 through the inlet 16. In the illustrated embodiment, the feed system 12 includes a plurality of hoppers 22, 24 for containing a supply of various ingredients 26, 28 of the composition 8. As shown, the feed system 12 includes a first hopper 22 and a second hopper 24, wherein the first hopper 22 contains a volume of a first ingredient 26 and the second hopper 24 contains a volume of a second ingredient 28. As shown, the first hopper 22 and the second hopper 24 converge in a single mixing chamber 30 configured to blend the first ingredient 26 and the second ingredient 28 in a predetermined proportion to form the composition 8. As discussed further below, the first ingredient 26 of the composition 8 may be a base resin, and the second ingredient 28 of the composition 8 may be a foaming agent. In alternate embodiments, the feed system 12 may include additional hoppers containing additional ingredients, such as nucleating agents and coloring agents, for example. Alternatively, the feed system 12 may include a single hopper, wherein the composition is mixed prior to provision to the feed system 12.

The head 14 of the injector 4 is disposed adjacent the outlet 18 of the barrel 10, and includes a nozzle 32 configured to convey the composition 8 from the barrel 10 to the mold 6. The head 14 may further include a shut-off valve 34 disposed therein, and configured to control a flow of the composition 8 into the mold 6. In one embodiment, the shut-off valve 34 may be a gate-valve system, wherein a plunger 36 is slidingly disposed within the nozzle 32 to selectively control a flow of the composition 8 into the mold 6. Other types of shut-off valves will be appreciated by those skilled in the art.

The mold 6 of the molding system 2 is configured to form the composition 8 into one of a plurality of components 38 for a vehicle HVAC system. The mold 6 includes a mold cavity 40 defined by a pair of dies 42, wherein each of the dies 42 is coupled to a respective platen 44. As shown, a first one of the platens 44 may be stationary, while a second one of the platens 44 may be moveable between an open position and a closed position to selectively enclose the mold cavity 40.

In the illustrated embodiment, a profile of the mold cavity 40 corresponds to a profile of a portion of a housing for a HVAC system. Particularly, the mold cavity includes a series of thin-walled legs corresponding to at least a first sidewall of the housing and a second sidewall of the housing. However, in alternate embodiments, the mold cavity 40 may define flow-control doors, vent panels and grills, actuating hardware, conduits, and other components commonly utilized in the assembly of vehicle HVAC systems.

The feed system 12, the barrel 10, and the dies 42 may each include at least one temperature control unit 46 for maintaining the composition 8 at a predetermined temperature. For example, heating temperature control units 46 may be included in at least one of the hoppers 22, 24 and/or the mixing chamber 30, wherein a temperature of the ingredients 26, 28 of the composition 8 is elevated above a melting temperature of the base resin to facilitate blending of the ingredients 26, 28. As shown, the heating temperature control units 46 of the injector 4 are heater bands at least partially circumscribing the barrel 10 of the injector 4. However, in alternate embodiments, the temperature control units 46 of the injector 4 may include both heating and cooling capabilities.

Additionally, at least one of the dies 42 of the mold 6 may include both heating temperature control units 46 and cooling temperature control units 46, wherein the heating temperature control units 46 are used to control decomposition of a chemical foaming agent 28, as described below, and the cooling temperature control units 46 are used solidify the base resin 26 and to further cool the HVAC component 38 after nucleation is complete, thereby expediting removal of the molded HVAC component 38 from the mold cavity 40. In the illustrated embodiment, the temperature control units 46 of the mold 6 comprise a plurality of conduits formed integrally with the dies 42 of the mold 6, wherein a heat transfer fluid is provided from an external source (not shown) to control a temperature of the mold cavity 40. In one embodiment, a single circuit of conduits is formed in the mold 6, wherein a single heat transfer fluid is used for heating and cooling of the dies 42. In alternate embodiments, a first circuit of conduits may be used for a cooling heat transfer fluid and a second circuit of conduits may be used for a heating heat transfer fluid.

The base resin 26 may be a pelletized or a fluid form of an organic thermoplastic such as polyethylene; ethylene-vinylacetate copolymer; ethylene-ethyleneacrylate; ionomeric polyethylene; polypropylene; polybutene; polymethylpentene; polystyrene; impact-resistant polystyrene; styrene-acrylonitrile copolymer; acrylic-butadienestyrene copolymer; acrylonitrile styrene acrylate; polyvinylcarbazole; polyoxymethylene; polyester; polyamide; polyvinyl chloride; polytrifluoroethylene; polytetrafluoroethylene-perfluoropropylene; polyvinylidene fluoride; ethylene-tetrafluoroethylene copolymer; polymethylmethacrylate; chlorinated polyether; phenoxy resin; polyphenylene oxide; polysulphone; polyethersulphone; polyphenylenesulphide; polyurethane elastomer; cellulose acetate; cellulose propionate; cellulose-acetobutyrate, or a combination thereof. Other thermoplastics or elastomers will be appreciated by those of ordinary skill in the art.

A passive nucleating agent may also be blended with the base resin 26 to provide a starting point from which gas bubbles begin to grow during formation of foam cells. In one embodiment, the passive nucleating agent is a solid material blended with the base resin. For example, the base resin 26 may include about 20% talc blended therewith. In alternate embodiments an active nucleating agent, such as the chemical foaming agent 28, may actively serve as the nucleating agent, thereby minimizing or eliminating the need for solid nucleating agents. Using the chemical foaming agent 28 has been discovered to be more efficient, and capable of providing a smaller and more uniform cellular structure than the use of solid nucleating agents.

The chemical foaming agent 28, also referred to as a blowing agent, is blended with the base resin 26. The chemical foaming agent 28 may be provided as an additive to the base resin 26 in powder form, wherein the chemical foaming agent 28 is contained within the second hopper 24, and blended with the base resin 26 in the mixing chamber 30 of the feed system 12 immediately prior to introduction into the inlet 16. The chemical foaming agent 28 may be mixed with the base resin 26 using a passive mixing means such as a gravity feed, or an active mixing means such as a screw, for example. Alternately, the base resin 26 may be provided as a master batch in a granular form, wherein the chemical foaming agent 28 is pre-blended with the base resin 26 in a desired proportion. In yet another embodiment, an operator may blend the base resin 26 and the chemical foaming agent 28 prior to provision of the composition 8 to the first hopper 22.

The chemical foaming agent 28 is configured to produce a cellular structure within the composition 8 by decomposing within the base resin 26 at a predetermined processing temperature and pressure. The decomposition of the chemical foaming agent 28 brings about the development of a blowing gas within the composition 8. In one example, the decomposition of the chemical foaming agent 28 may bring about the development of a CO) gas. The decomposition of the chemical foaming agent 28, and subsequent formation of gas bubbles within the composition 8 is often referred to as nucleation.

The chemical foaming agent 28 may be an endothermic chemical foaming agent. The endothermic chemical foaming agent requires an input of energy to initiate and maintain decomposition. Examples of the endothermic chemical foaming agent include sodium bicarbonate and citric acid. In a particular embodiment, the endothermic chemical foaming agent is based on monoesters and diesters of citric acid. Particularly, it has been surprisingly discovered that a chemical foaming agent 28 formed of a monoester or diester of citric acid having up to 8 carbon atoms performs particularly well in the formation of thin-walled HVAC components. Those of ordinary skill in the art will appreciate that other endothermic chemical foaming agents may also be utilized.

Alternately, the chemical foaming agent 28 may be an exothermic chemical foaming agent. In contrast to the endothermic blowing agent, the exothermic chemical foaming agent requires an input of energy to initiate decomposition, but releases energy once decomposition has started. In exothermic reactions, decomposition continues spontaneously until all of the chemical foaming agent 28 is consumed. Examples of the exothermic chemical foaming agent include hydrazines and azo or diazo compounds.

The use of the endothermic chemical foaming agent in the manufacture of HVAC components provides several advantages over the use of a physical blowing agent and the exothermic chemical foaming agent. By requiring a continuous input of energy to maintain the decomposition process, the reaction rate can be controlled and reaction products can be retained in solution until nucleation can be initiated via the reduced pressures and temperatures present in the mold cavity 40, thereby allowing a density and a volume of the composition 8 to be precisely controlled. Nucleation using the endothermic chemical foaming agent 28 also has the advantageous effect of consuming energy from the mold 6 during nucleation, which allows a temperature of the mold cavity 40 to be minimized. The minimized temperature of the mold cavity 40 is advantageous, as it allows the HVAC component 38 formed within the mold cavity 40 to be removed from the mold cavity 40 more quickly, thereby minimizing process times. The minimized temperature of the mold cavity 40 also provides the benefit of allowing outer surfaces of the HVAC component 38 to be rapidly cooled upon introduction to the mold cavity 40, thereby minimizing surface nucleation to allow formation of a smooth outer “skin” on the part. A smooth outer skin is particularly beneficial in HVAC components 38, as it eases manufacturing and assembly of individual HVAC components 38 by maximizing dimensional control, providing better aesthetic appearance, providing greater physical property retention, and maximizing aerodynamic performance of individual components 38 by minimizing surface drag.

Within the feed system 12, the composition 8 is maintained at a first temperature range. The first temperature range is below a melting point of the base resin 26 and a decomposition temperature of the chemical foaming agent 28, wherein the base resin 26 remains in a solid form. The composition 8 is then conveyed from the feed system 12 and into the barrel 10 under the action of gravity. Within the barrel 10, energy is input into the composition 8 to transition the base resin 26 from a solid form to a molten form, and to initiate decomposition of the chemical foaming agent 28 within the composition 8. Energy may be input to the composition 8 by at least one of the temperature control units 46. Energy may also be input to the composition 8 by the screw 20 in the form of shear and pressure forces. Particularly, a temperature of the composition 8 within the barrel may be maintained at a temperature between 150° C. and 300° C. Optimal temperature ranges will depend on a type of base resin 26 and chemical foaming agent 28 included in the composition, wherein a selected temperature will be sufficient to initiate decomposition of the chemical foaming agent 28 at a desired rate, while maintaining the base resin 26 in a suitable physical state.

As the chemical foaming agent 28 decomposes, the composition 8 is maintained under pressure within the barrel 10 by the screw 20. Accordingly, the blowing gas formed by the decomposed chemical foaming agent 28 within the composition 8 is maintained under pressure and remains entrained within the composition 8, thereby minimizing nucleation.

The composition 8 is then introduced into the mold cavity 40 through the nozzle 32 of the injector 4. A predetermined amount of the composition 8 is fed into the mold cavity 40 based on several factors including: final part volume and wall thicknesses, chemical foaming agent type, and chemical foaming agent concentration. The predetermined amount of the composition 8 may be an amount sufficient to partially fill the mold cavity 40, thereby allowing space in the mold cavity 40 for expansion of the composition 8. Introduction of the composition 8 into the mold cavity 40 may be metered in several ways. For example, a speed of the screw 20 may be controlled to effect a volumetric flow rate of the composition 8 into the mold cavity 40. Alternately, the shut-off valve 34 may be relied upon to selectively control the volumetric flow rate of the composition 8 into the mold cavity 40.

Upon introduction of the composition 8 into the mold cavity 40, the reduced pressures within the mold cavity 40 allow the blowing gas to begin nucleation, wherein a suspension of gas bubbles is allowed to form and grow within the composition 8, thereby forming a cellular structure within the composition 8. Nucleation is controlled by a combination of a temperature of the mold cavity 40, a pressure of the mold cavity 40, and a thickness of a wall of the part, among other factors. The temperature of the mold cavity 40 may be maintained at an elevated state sufficient to sustain decomposition of the chemical foaming agent 28 within the composition 8, as desired.

The use of chemical foaming agents in the manufacture of HVAC components offers several benefits over the prior art. For example, the use of chemical foaming agents provides a foam material having superior noise and vibrational damping and thermal insulation compared to HVAC components formed according to the prior art. By using the disclosed method of forming HVAC components, a weight of the component and energy consumption during formation of the component are minimized while a solid surface layer and cellular core are maintained.

The use of chemical foaming may also provide manufacturing benefits, such as allowing the foaming process to be implemented without the need for specialized injection molding equipment or increased raw material costs. Additionally, when an endothermic chemical foaming agent is used, process times are minimized by maintaining a relatively cool mold cavity 40 compared to physical foaming and exothermic chemical foaming. HVAC components formed using the disclosed method also exhibit improved dimensional accuracy through reduced differential shrinkage, increased speed of manufacture, and an ability to fill a mold cavity 40 quicker and with reduced resistance to material flow compared to physical foaming and hollow glass bubble foaming. Reduced shrink and therefore better contact with the mold surface will further add efficiency to the cooling.

The use of the disclosed method minimizes molding cycle times by minimizing the temperature of the mold through use of an endothermic chemical foaming agent. Additionally, the disclosed method minimizes energy consumption of the mold system 2, as a viscosity of the composition 8 may be minimized by the inclusion of the chemical foaming agent 28. Furthermore, the disclosed method may provide lower press clamp tonnage, improve dimensional control, and increase a flexural modulus of the material with minimal loss of strength or smooth surface appearance. The use of the disclosed method also provides improved HVAC component performance such as improved noise and vibration damping, and improved thermal insulation over the prior art, for example.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method of forming a component of a vehicle heating, ventilation, and air-conditioning system from a polymeric material, the method comprising the steps of:
providing a molding system including at least one mold cavity, the mold cavity including a die configured to form the component of the vehicle heating, ventilation, and air-conditioning system;
injecting a composition into the mold cavity, the composition including a base resin and a foaming agent, wherein a pressure within the mold cavity initiates gas bubble formation within the base resin.

2. The method of claim 1, wherein the foaming agent is a chemical foaming agent.

3. The method of claim 2, wherein the chemical foaming agent is one of an endothermic chemical foaming agent.

4. The method of claim 3, wherein the base resin is an organic thermoplastic.

5. The method of claim 1, wherein the base resin and the foaming agent are blended in an injector to form the composition prior to injection into the mold cavity.

6. The method of claim 5, wherein the injector includes a feed system including a pair of hoppers, a first one of the hoppers containing the base resin and a second one of the hoppers containing the foaming agent, wherein the base resin and the foaming agent are blended in the feed system to form the composition.

7. The method of claim 6, further comprising the step of feeding the composition into a barrel of the injector, wherein a temperature of the barrel is greater than the decomposition temperature of the foaming agent and a pressure of the barrel maintains the composition in a compressed state to minimize nucleation of the composition.

8. The method of claim 6, wherein the pressure within the mold cavity is less than the pressure of the barrel.
